(19) United States
(12) Patent Application Publication
(10) Pub. No.: US 2021/0333374 A1
(43) Pub. Date: Oct. 28, 2021

(54) RANGING APPARATUS AND MOBILE PLATFORM

(71) Applicant: SZ DJI TECHNOLOGY CO., LTD., Shenzhen (CN)

(72) Inventors: Shuai DONG, Shenzhen (CN); Li WANG, Shenzhen (CN); Xiongze MEI, Shenzhen (CN); Han CHEN, Shenzhen (CN)

(21) Appl. No.: 17/371,927

(22) Filed: Jul. 9, 2021

Related U.S. Application Data
(63) Continuation of application No. PCT/CN2019/070955, filed on Jan. 9, 2019.

(51) Int. Cl. G01S 7/487; G01S 7/481

(52) U.S. Cl. CPC G01S 7/4876; G01S 7/4817; G01S 7/4816

(57) ABSTRACT

A ranging apparatus includes an emitter and a detector. The emitter is configured to emit a light pulse sequence. The detector is configured to receive and convert a portion of return light reflected by an object into an electrical signal and determine at least one of a distance or an orientation of the object relative to the ranging apparatus according to the electrical signal. At least one of an anti-reflection material or a reflective surface with a predetermined inclined angle is arranged at a non-working surface off an emission optical path of the light pulse sequence and a reception optical path of the return light and is configured to reflect stray light to outside of the detector. The non-working surface includes a surface of the ranging apparatus that the light pulse sequence and the return light do not pass through.

### CROSS-REFERENCE TO RELATED APPLICATION

This application is a continuation of International Application No. PCT/CN2019/070955, filed Jan. 9, 2019, the entire content of which is incorporated herein by reference.

### TECHNICAL FIELD

The present disclosure generally relates to the ranging apparatus technology field and, more particularly, to a ranging system and a mobile platform.

### BACKGROUND

A ranging apparatus, e.g., a LIDAR, is a perception system of an external world. The LIDAR based on a principle of time of flight (TOF) is taken as an example. The LIDAR emits a pulse to the outside and receives a return wave generated and reflected by an external object. By measuring a time delay of the return wave, a distance between the object and the LIDAR in an emission direction is calculated. By dynamically adjusting the emission direction of a laser, distance information between objects in different directions and the LIDAR can be measured. Thus, a three-dimensional space model is realized.

Currently, when the ranging apparatus, such as the LIDAR, with coaxial emission and reception, is used, the following problems occur.

1. A part of the emitted light will be directly or after reflected by a working surface of an optical element projected to a non-working surface of a structure member or an optical element to form stray light. After one or more reflections, the stray light may be received by a receiving detector, which is an important source for forming return wave T0 in the LIDAR. Return wave T0 will interfere with the LIDAR for detecting a nearby object and affect the overall performance of the system.

2. When another light source exists in an application environment of the LIDAR, light from the other light source is received and detected by the detector through a path such as sidewall scattering, which causes a background noise to increase, a signal-to-noise ratio to reduce, and system ranging performance to weaken, or a false alarm noise to increase.

3. When a plurality of LIDARs are used simultaneously, crosstalk will be generated among the plurality of LIDARs. A LIDAR receives a light pulse emitted by another LIDAR to generate a crosstalk noise.

Therefore, because of the above problems, it is needed to improve the ranging apparatus.

### SUMMARY

Embodiments of the present disclosure provide a ranging apparatus including an emitter and a detector. The emitter is configured to emit a light pulse sequence. The detector is configured to receive and convert a portion of return light reflected by an object into an electrical signal and determine at least one of a distance or an orientation of the object relative to the ranging apparatus according to the electrical signal. At least one of anti-reflection material or a reflective surface with a predetermined inclined angle is arranged at a non-working surface off an emission optical path of the light pulse sequence and a reception optical path of the return light and is configured to reflect stray light to outside of the detector. The non-working surface includes a surface of the ranging apparatus that the light pulse sequence and the return light do not pass through.

Embodiments of the present disclosure provide a mobile platform including a platform body and a ranging apparatus. The ranging apparatus is arranged at the platform body and includes an emitter and a detector. The emitter is configured to emit a light pulse sequence. The detector is configured to receive and convert a portion of return light reflected by an object into an electrical signal and determine at least one of a distance or an orientation of the object relative to the ranging apparatus according to the electrical signal. At least one of anti-reflection material or a reflective surface with a predetermined inclined angle is arranged at a non-working surface off an emission optical path of the light pulse sequence and a reception optical path of the return light and is configured to reflect stray light to outside of the detector. The non-working surface includes a surface of the ranging apparatus that the light pulse sequence and the return light do not pass through.

### BRIEF DESCRIPTION OF THE DRAWINGS

FIG. 1 is a schematic diagram of a part of a ranging apparatus of some embodiments of the present disclosure.

FIG. 2A is a schematic diagram showing crosstalk between different ranging apparatuses according to some embodiments of the present disclosure.

FIG. 2B is a schematic diagram showing crosstalk between different ranging apparatuses according to some other embodiments of the present disclosure.

FIG. 2C is a schematic diagram showing crosstalk between different ranging apparatuses according to some other embodiments of the present disclosure.

FIG. 3 is a schematic diagram of a part of a ranging apparatus according to some other embodiments of the present disclosure.

FIG. 4 is a schematic diagram of a part of a ranging apparatus according to some other embodiments of the present disclosure.

FIG. 5 is a schematic diagram of a part of a ranging apparatus according to some other embodiments of the present disclosure.

FIG. 6 is a schematic architectural diagram of a ranging apparatus according to some embodiments of the present disclosure.

FIG. 7 is a schematic diagram of a ranging apparatus according to some embodiments of the present disclosure.

### DETAILED DESCRIPTION OF THE EMBODIMENTS

To make purposes, technical solutions, and advantages of the present disclosure clearer, embodiments of the present disclosure are described in conjunction with the accompanying drawings below. The described embodiments are only some embodiments not all the embodiments of the present disclosure. The present disclosure is not limited by embodiments described here. Based on the embodiments of the disclosure, all other embodiments obtained by those of ordinary skill in the art without any creative work are within the scope of the present disclosure.

In the following description, a lot of specific details are given to provide a more thorough understanding of the present disclosure. However, it is obvious to those skilled in the art that the present disclosure can be implemented without one or more of these details. In other examples, to avoid confusion with the present disclosure, some technical features are known in the art are not described.

The present disclosure may be implemented in different forms and should not be understood to be limited by the described embodiments. On contrary, providing these embodiments will cause the present disclosure to be thorough and complete, and will fully convey the scope of the present disclosure to those skilled in the art.

Terms used in the present disclosure describe merely specific embodiments but are not intended to limit the present disclosure. The singular forms of “a,” “one,” and “said/the” used in the present disclosure and the appended claims are also intended to include plural forms unless the context indicates other meanings. When the terms “including” and/or “containing” are used in the specification, the existence of the described features, integers, steps, operations, elements, and/or components is determined, but do not exclude the existence or addition of one or more other features, integers, steps, operations, elements, and/or components. As used herein, the term “and/or” includes any and all combinations of related listed items.

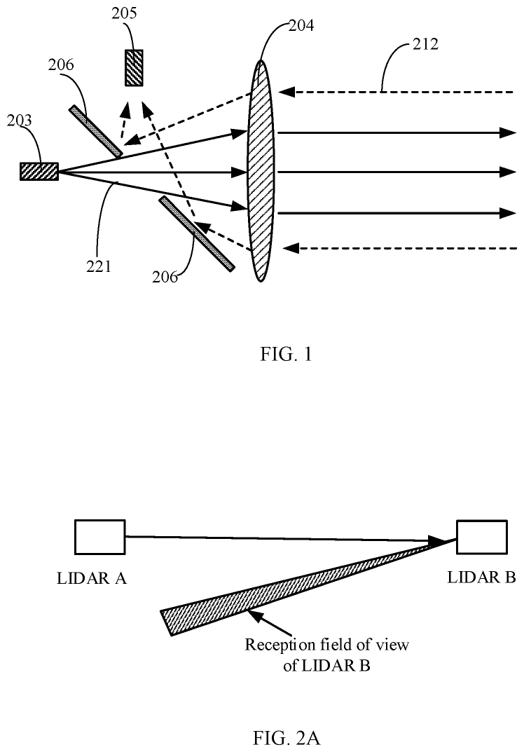

A ranging apparatus with coaxial emission and reception, such as a LIDAR, may reduce system complexity and be beneficial to reduce cost. A reflection mirror may need to be added into an optical path to separate the reception and the emission optical paths to measure a received return wave. As shown in FIG. 1, the ranging apparatus is a typical ranging apparatus with coaxial emission and reception. In such a structure, a light pulse sequence 221 emitted by an emitter 203 passes through a light-transmission area of an optical path change element 206. A collimation element 204 is arranged in an emission optical path of a light source. The collimation element 204 may be configured to collimation a beam emitted by the light source 103 and collimate the beam emitted by the emitter 203 into parallel light. After the parallel light is projected on an object, return light 212 reflected by the object may be converged by the collimation element 204 and then projected to an outer side of the light-transmission area of an optical path change element 206, is reflected and received by a detector 205 to measure a distance.

However, the current ranging apparatus with coaxial emission and reception may have the following problems.

1. A part of the emitted light will be directly or after reflected by a working surface of an optical element projected to a non-working surface of a structure member or an optical element to form stray light. After one or more reflections, the stray light may be received by a receiving detector, which is an important source for forming return wave T0 in the LIDAR. Return wave T0 will interfere with the LIDAR for detecting a nearby object and affect the overall performance of the system.

2. When another light source exists in an application environment of the LIDAR, light from the other light source is received and detected by the detector through a path such as sidewall scattering, which causes a background noise to increase, a signal-to-noise ratio to reduce, and system ranging performance to weaken, or a false alarm noise to increase.

3. When a plurality of LIDARs are used simultaneously, a crosstalk will be generated among the plurality of LIDARs. A LIDAR receives a light pulse emitted by another LIDAR to generate a crosstalk noise.

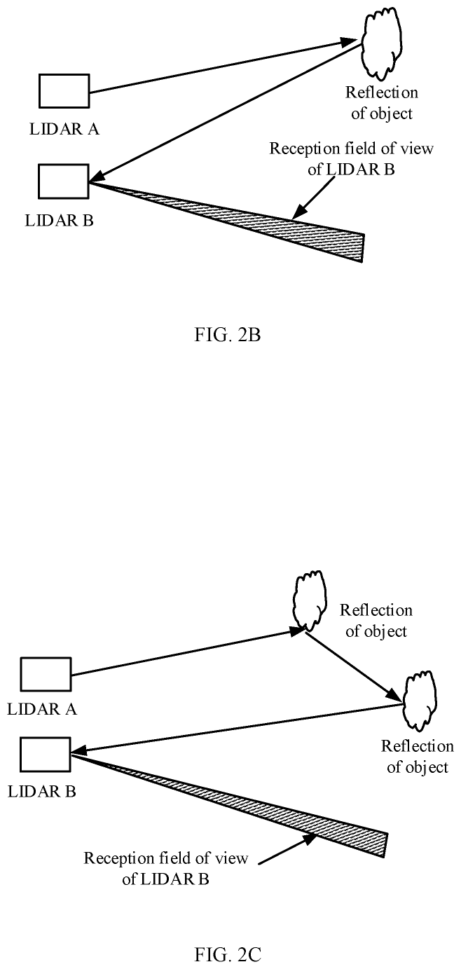

In connection with FIG. 2A to FIG. 2C, a crosstalk problem among the plurality of ranging apparatuses such as the LIDARs are explained and described below. For example, a plurality of ranging apparatuses may be arranged in a car, or one or more ranging apparatuses are arranged in a plurality of mobile platforms in the environment. With such a setting, crosstalk may be generated among the plurality of ranging apparatuses. That is, an optical signal emitted by a ranging apparatus may be received by another ranging apparatus. Thus, a noise point may be generated.

In some embodiments shown in FIG. 2A, a light pulse emitted by LIDAR A is projected at LIDAR B. The light pulse is not in a reception field of view of LIDAR B. However, the light pulse emitted by LIDAR A may be reflected by various structures of LIDAR B and eventually received by a detector of LIDAR B (an optical signal received by LIDAR B that is generated by structural scattering is referred to as “stray light” below), forming noise.

In some embodiments shown in FIG. 2B, a position of an object where a light pulse emitted by LIDAR A is projected is not in a reception field of view of LIDAR B. The light pulse emitted by LIDAR A is projected to LIDAR B after reflected by the object and received as stray light by the detector of LIDAR B to generate a noise.

In some embodiments shown in FIG. 2C, after being projected to an object, the light pulse emitted by LIDAR A is projected to LIDAR B after a plurality of times of reflection. The light pulse may be received by LIDAR B as stray light to form a noise (i.e., noise point).

In some embodiments, the light pulse emitted by LIDAR A or the light pulse emitted by LIDAR A reflected by the object may be not in the reception field of view of LIDAR B, but may be projected to LIDAR B and may be reflected/refracted in LIDAR B. Then, a light pulse may be received by the LIDAR B to generate the noise.

In some embodiments, the ranging system may include at least two ranging apparatuses. A number of the at least two ranging apparatuses may be 2, 3, 4, 5, or more. The at least two ranging apparatuses may be arranged at different mobile platforms or a same mobile platform. The mobile platform may include a mobile platform moving in the air or on the ground, such as an unmanned aerial vehicle (UAV), a robot, a car, or a ship.

In some embodiments, the at least two ranging apparatuses may include two neighboring ranging apparatuses arranged on a same platform. Since the two ranging apparatuses are neighboring and close to each other, a laser pulse sequence emitted by one of the two ranging apparatuses may be received by the other one of the two ranging apparatuses. Thus, crosstalk may be generated easily.

In some other embodiments, the at least two ranging apparatuses may include two ranging apparatuses that are arranged on the same platform, and fields of views (FOVs) of the two ranging apparatuses may have an overlapped portion. The two ranging apparatuses may be neighboring ranging apparatuses or ranging apparatuses spaced at an interval. Since the FOVs of the ranging apparatuses have the overlapped portion, the crosstalk problem may be easily generated.

In some other embodiments, the at least two ranging apparatuses may include two ranging apparatuses arranged on the same mobile platform having a same detection direction or two ranging apparatuses arranged on a same side of the same mobile platform. The crosstalk problem may be easily generated between the two ranging apparatuses according to the setting manner.

For the above problems, the ranging apparatus of the present disclosure may be improved to reduce or avoid the crosstalk. The present disclosure provides the ranging apparatus. The ranging apparatus may include an emitter and a detector. The emitter may be configured to emit a light pulse sequence. The detector may be configured to convert at least a part of the return light that is reflected by the object into an electrical signal, and determine the distance and/or orientation of the object to the ranging apparatus according to the electrical signal. An anti-reflection material and/or a reflective surface with a predetermined inclined angle may be arranged on at least a portion of a non-working surface off an emission optical path of the light pulse sequence and the reception optical path of return light to reflect stray light to outside of the detector. The non-working surface may include a surface that the light pulse sequence and the return light do not passed through. In the solution of embodiments of the present disclosure, by arranging the anti-reflection material on the non-working surface, the stray light may be reduced, and density of return wave T0 inside the ranging apparatus may be reduced. The system performance may be improved, and the crosstalk noise among the plurality of ranging apparatuses may be reduced. Further, the stray light noise received by the ranging apparatus may be reduced, and the ranging performance of the system may be improved.

In the solution of embodiments of the present disclosure, by arranging a reflective surface with a predetermined inclined angle on at least a part of the non-working surface, the stray light may be reflected to the outside of the detector of the ranging apparatus. Since the at least a portion of the non-working surface is arranged as the reflective surface with the predetermined inclined surface, the stray light projected on the reflective surface may be transmitted out in a specific direction after the direction of the stray light is changed by the reflective surface. Therefore, the direction of the stray light may be well controlled, and the stray light may be reflected to the outside of the detector of the ranging apparatus. Thus, the noise may be reduced or eliminated, and the ranging performance of the ranging apparatus may be improved.

To understand the present disclosure, a detailed structure is provided in the following description to explain the technical solution proposed by the present disclosure. Embodiments of the present disclosure are described in detail as follows. However, in addition to the detailed description, the present disclosure may include other embodiments. The ranging apparatus of the present disclosure is described in detail below in connection with the accompanying drawings. Where there is no conflict, embodiments and features of embodiments may be combined with each other.

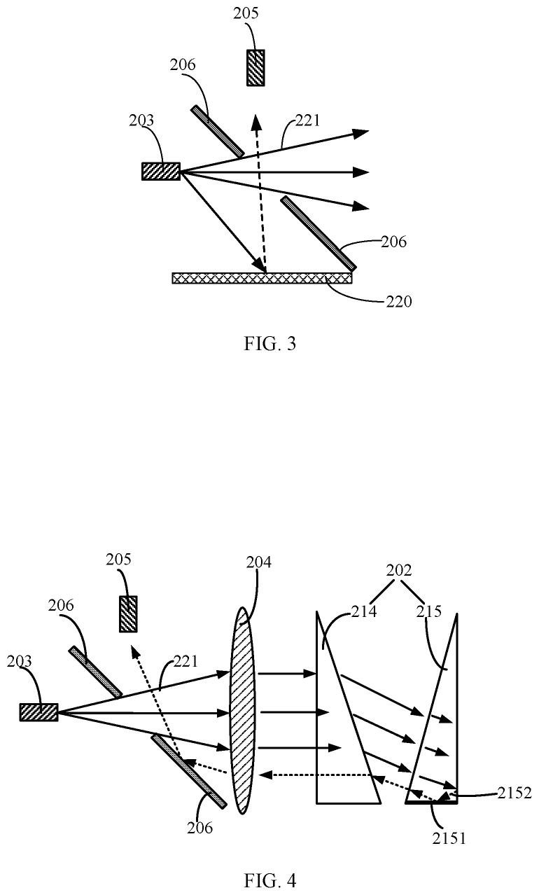

In some embodiments, as shown in FIG. 3, the ranging apparatus includes an emitter 203. The emitter 203 may be configured to emit a light pulse sequence 221, such as a laser pulse sequence. The ranging apparatus also includes a detector 205. The detector 205 may be configured to receive a return light, and convert at least a part of the return light into an electrical signal, and determine the distance and/or orientation of the object from the ranging apparatus according to the electrical signal.

In some embodiments shown in FIG. 3, the ranging apparatus also includes an optical path change element 206. An emission optical path and a reception optical path of the ranging apparatus may be combined through the optical path change element 206 before the collimation element 204 to change a direction of the emission optical path or the reception optical path. Thus, the emission optical path and the reception optical path can be combined, such that the emission optical path and the reception optical path may share the same collimation element to cause the optical path to be more compact. In some other embodiments, each of the emitter 203 and the detector 205 may include a collimation element. The optical path change element 206 is arranged at the optical path after the collimation element.

In some embodiments shown in FIG. 3, a light-transmission area is arranged at the optical path change element 206. The light-transmission area may be arranged at the central area of the of the optical path change element 206, or an area off the central area. In some embodiments, the optical path change element 206 may also include a reflection mirror with a light-transmission area arranged at the central area, such as a reflection mirror with a through-hole. The though-hole may be configured to transmit the light pulse sequency 221 emitted by the emitter 203. The reflection mirror may be configured to reflect the return light to the detector 205. As such, when a small reflection mirror is used, shielding of the return light by the holder of the small reflection mirror may be reduced. Since a light divergence angle of the beam emitted by the light source 103 is small, and the light divergence angle of the return light received by the ranging apparatus is large, the optical path change element 206 may be configured to combine the emitting optical path and the receiving optical path by using the reflection mirror with the small area.

In some embodiments, the ranging apparatus may include a structure member. The non-working surface may include a portion of a surface of the structural element. The structural member may include a housing of the ranging apparatus. The housing may include a accommodation chamber, and the emitter and the detector are arranged in the accommodation chamber. The structure member may further include a support member. The support member may be configured to support the optical elements included in the ranging apparatus. The optical elements may include, but be not limited to, the optical path change element, the collimation element, and the optical element of the scanner. The non-working surface may include a portion of the surface of the structure member, e.g., at least a portion of an inner surface of the housing. The portion of the inner surface may include a surface facing the emitter and/or the detector. In some other embodiments, the non-working surface may further include a portion of the surface of an optical device included in the ranging apparatus facing the emitter and/or the detector.

In some embodiments, the divergence angle of the light pulse sequence 221 emitted by the emitter 203 may be greater than an opening angle of the light-transmission area of the optical path change element 206 relative to the emitter 203, e.g., the reflection mirror with a through-hole of the optical path change element 206. The through-hole may be arranged at the central area of the reflection mirror. The divergence angle of the light pulse sequence 221 emitted by the emitter 203 may be larger than the opening angle of the through-hole of the optical path change element 206 relative to the emitter 203. At least a portion of the light pulse sequence 221 emitted by the emitter 203 may pass through the light-transmission area. A portion of the light pulse sequence 221 may be projected on the surface that faces the emitter 203 and is opposite to the light-transmission area (i.e., the non-working surface), for example, at least a portion of the surface of optical path change element 206 facing the emitter, or the at least a portion of the structure member surface facing the emitter 203. In some embodiments shown in FIG. 3, a portion of the light pulse sequence emitted by the emitter 203 is projected to a surface of a first structure member 220 that faces the emitter 203. If no processing is performed on the surface, after diffuse reflection on the surface, stray light is generated (indicated by the dashed line in FIG. 3). The stray light is reflected by the structure member 220 to pass through the light-transmission area of the optical path change element 206 and detected by the detector 205 to generate return wave T0. As such, the non-working surface may include the above-mentioned surface. Thus, the at least a portion of the above-mentioned surface may be arranged with anti-reflection material and/or a reflective surface with a predetermined inclined angle to reflect the stray light to the outside of the detector.

In some embodiments, the non-working surface may include an area on the surface of the optical path change element 206 facing the emitter 203 that receives a portion of the light pulse sequence other than a portion of the light pulse sequence passing through the light-transmission area. Moreover, the non-working surface may include the whole surface of the optical path change element 206 facing the emitter 203 other than the light-emission area.

In some other embodiments shown in FIG. 3, the non-working surface includes at least a portion of the surface of the first structure member 220 that is configured to support the optical path change element 206. The at least a portion of the surface may face the emitter 203 and receive a portion of the light pulse sequence other than the portion of the light pulse sequence passing through the light-transmission area. Moreover, the non-working surface may further include the whole surface of the first structure member 220 facing the emitter 203.

In some embodiments shown in FIG. 4, the ranging apparatus also includes a collimation element 204. The collimation element 204 may be arranged on an emission path of the emitter 203. The collimation element 204 may be configured to collimate the light pulse sequence emitted by the emitter 203 and then project the light pulse sequence out. The collimation element 204 may be further configured to converge the at least a portion of the return light reflected by the object to the detector 205. The collimation element 204 may include but not limited to a lens or another suitable collimation element.

As shown in FIG. 4, the ranging apparatus further includes a scanner 202. The scanner 202 may be configured to change transmission directions of the light pulse sequences to different directions in sequence and project out. The scanner 202 may include at least one optical element. The optical element may be configured to change the transmission path of the light pulse sequence. The optical element may include two opposite surfaces that are not parallel and a side surface that locates at a circumferential edge. The non-working surface may include the side surface of the optical element located at the circumferential edge. In some embodiments, the at least a portion of the non-working surface of the optical element may include a surface that may reflect a portion of the light pulse sequence, such as the side surface of the optical element located at the circumferential edge.

The thickness of the optical element may gradually increase from a first end to a second end that is opposite to the first end. Further, the anti-reflection material may be arranged at the end surface of the second end (i.e., side surface). For example, as shown in FIG. 4, the optical element includes a first optical element 214 and a second element 215 that are arranged along the emission optical path of the emitter in sequence. The non-working surface includes the end surface 2151 of the second end of the second optical element 215.

In some embodiments, at least a portion of the non-working surface of the optical element may include a surface that can reflect the portion of the light pulse sequence. After being reflected by the non-working surface, the portion of the light pulse sequence may be reflected and/or refracted at least once to the detector. As shown in FIG. 4, the emitted light of the emitter 203 passes through the through-hole of the optical path change element and is collimated by the collimation element 204. The light may be deflected by passing through the first optical element 214, and a portion of the light may be reflected by the non-working surface of the second optical element 215. The reflected light 2152 may be projected to the non-working surface of the second optical element 215 (e.g., the end surface of 2151). After being reflected by the end surface 2151, the light may be finally received by the detector 205 through reflection and refraction for multiple times to generate return wave T0. The reflection ratio may be significantly reduced by arranging the anti-reflection material at the non-working surface of the second optical element 215. Thus, an intensity of reflected light 2152 may be greatly reduced, and return wave T0 may be reduced. In some other embodiments, the reflective surface with the predetermined inclined angle may be arranged at the non-working surface of the second optical element 215 (e.g., the end surface 2151), which may reflect the reflected light to the outside of the detector and control the reflection direction to make the reflected light not be received by the detector to reduce return wave T0.

In the specification, the stray light may include the light received by the detector after the portion of the light pulse sequence emitted by the emitter that is not used for detection is reflected and/or refracted for at least once, and/or another light received by the detector that is not the light pulse sequence and the return light and is reflected and/or refracted for at least once.

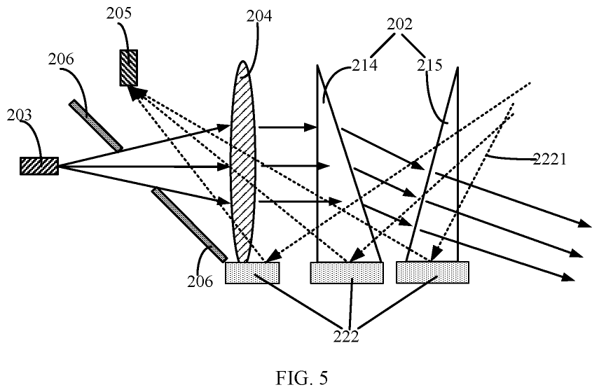

In some other embodiments shown in FIG. 5, the ranging apparatus also includes a second structure member 222. The second structure member 222 may be configured to support the collimation element 204 and the optical element of the scanner, e.g., the first optical element 214 and the second optical element 215. The second structure member 222 may include an integral structure that may be configured to support the collimation element 204 and the optical elements that are arranged at an interval with the collimation element 204. In some embodiments, each of the optical elements of the collimation element 204 and scanner may include a different second structure member 222.

The light pulse emitted by another ranging apparatus may be directly projected to or reflected by the object as stray light to enter the ranging apparatus. The stray light may be received by the detector after being reflected by the inner wall of the ranging apparatus for a single or a plurality of times to generate the crosstalk noise. For example, as shown in FIG. 5, light emitted by another ranging apparatus or light 2221 emitted by another light source in the space faces the surface of the detector 205 after passing through the second structure member 222. The light may be received by the detector 205 after being reflected or refracted by the first optical element 214 and/or the second optical element 215 and/or the sidewall (non-working surface) of the collimation element 204 to generate the crosstalk noise. Therefore, the non-working surface of the second structure member 222 may include a surface that can reflect the stray light to the detector. In some embodiments, the non-working surface of the second structure member may include the surface that face the detector and can reflect at least a portion of the stray light to the detector. An anti-reflection material and/or a reflective surface with a predetermined inclined angle may be arranged at another surface of the optical element or another surface of the structure member in addition to the optical working surface. Thus, energy of the stray light received by the detector may be reduced, and the crosstalk may be effectively reduced.

In some embodiments, to reduce or eliminate the crosstalk, an anti-reflection material (not shown) may be arranged the at least a portion of the non-working surface off the emission optical path of the light pulse sequence and the reception optical path of the return light. The non-working surface may include a surface that the light pulse sequence and the return light do not pass through. The non-working surface includes the above-mentioned surface and another non-working surface that may generates the crosstalk. With such a setting, the reflection ratio of the non-working surface may be significantly reduced, and the stray light intensity reflected by the non-working surface may be significantly reduced. Thus, the intensity of return wave T0 inside the ranging apparatus may be reduced. The crosstalk and the noise generated by the stray light in the environment may be reduced, and the system performance may be increased.

Anti-reflection material may include at least one of a light absorption material or a low reflection ratio material. The low reflection ratio material may include a low reflection ratio material with a reflection ratio less than 20%. Further, the low reflection ratio material may also include a low reflection ratio material with a reflection ratio less than 10%. The lower the reflection ratio is, the better the low reflection ratio material is. The low reflection ratio material may include a low reflection ratio coating or an adhesive film with a low reflection ratio material on the surface, or any other suitable low reflection ratio material. The anti-reflection material may be arranged on the non-working surface by spraying or adhering.

The light absorption material may include at least one of light elimination oil ink, a black glue, or black foam, or another suitable light absorption material. The light absorption material may be sprayed or adhered to the non-working surface. For example, the light absorption material, such as the light elimination oil ink and the black glue, may be arranged at the non-working surface by painting or spraying. For example, the light absorption material, such as the black foam may be arranged at the non-working surface in an adhesive manner.

In some other embodiments, to reduce and eliminate the crosstalk, a reflective surface with a redetermined inclined angle may be arranged at at least a portion of the non-working surface off the emission optical path of the light pulse sequence and the reception optical path of the return light to reflect the stray light to the outside of the detector. The non-working surface may include a surface that the light pulse sequence and the return light do not pass through. The non-working surface may include the above-described surface and another non-working surface that may cause crosstalk. Since the reflective surface with the predetermined included angle is arranged at at least a portion of the non-working surface, the stray light that is incident to the reflective surface may be reflected by the reflective surface. A direction of the stray light after the reflection may be more controllable. By appropriately setting the predetermined inclined angle, the stray light may be controlled to be reflected to the outside of the detector to reduce or eliminate the crosstalk. Reducing and eliminating the crosstalk may include reducing or eliminating return wave T0 to reduce the crosstalk and the noise generated by the stray light in the environment to increase the system performance.

An inclined degree of the predetermined inclined angle of the reflective surface may be set appropriately according to the direction of the stray light reflected by the reflective surface and the position of the detector. As long as the stray light can be reflected to the outside of the detector, any suitable predetermined inclined angle may be applied. The reflective surface may be formed by arranging a portion of the non-working surface as an inclined surface with the predetermined inclined angle and arranging the inclined surface as a mirror surface. In some embodiments, the reflective surface with the predetermined inclined angle may be arranged at the portion of the non-working surface that is off the emission optical path of the light pulse sequence and the reception optical path of the return light in another suitable manner to reflect the stray light to the outside of the detector.

In summary, the solution of embodiments of the present disclosure may reduce and eliminate return wave T0 to avoid the return wave T0 from generating the crosstalk when the ranging apparatus detects a nearby object to increase the whole performance of the system. When the plurality of ranging apparatuses are used simultaneously, the solution of the present disclosure may further reduce and eliminate the crosstalk among different ranging apparatuses. In addition, when another light source exists in an application environment of the ranging apparatus, the solution of the present disclosure may further avoid light of another light source to be received by the detector to reduce or eliminate the background noise. Thus, the signal to noise ratio may be increased, the ranging performance of the system may be optimized, and the false alarm noise may be weakened or eliminated.

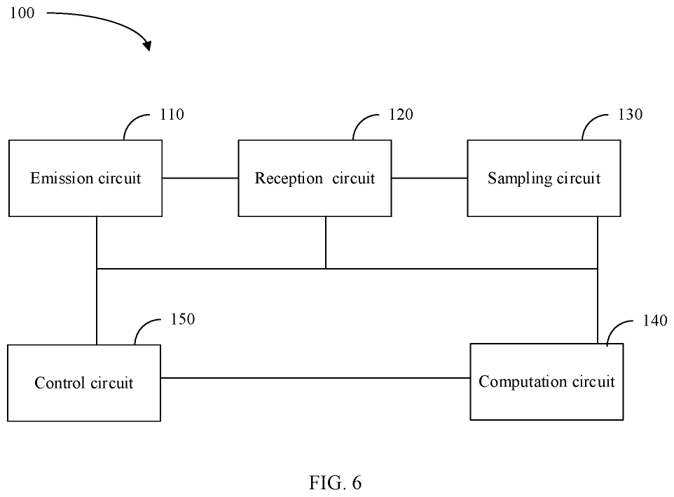

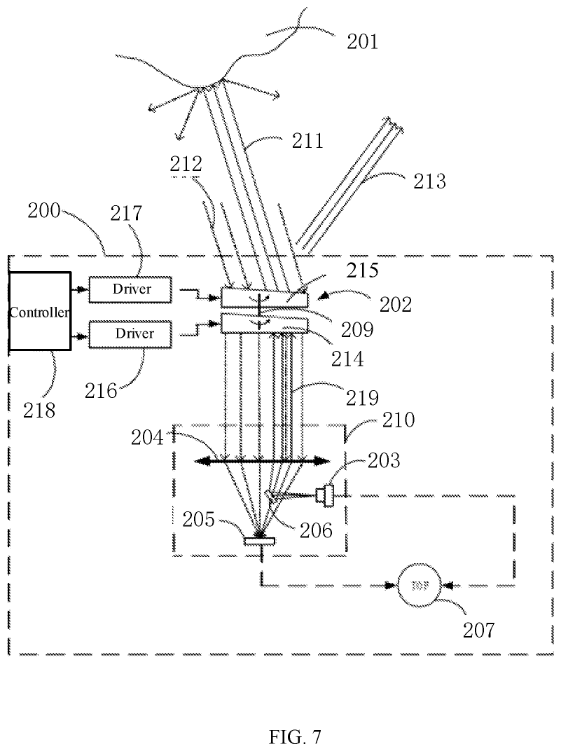

Referring to FIG. 6 and FIG. 7, a structure of a ranging apparatus of embodiments of the present disclosure is described exemplarily. The ranging apparatus includes a LIDAR. The ranging apparatus is merely an example. Another appropriate ranging apparatus may be also applied in the present disclosure.

Various embodiments of the present disclosure provide that anti-reflection material and/or reflection with preset incline angle may be applied in the ranging apparatus. The ranging apparatus may include an electronic apparatus such as a LIDAR, a laser ranging apparatus, etc. In some embodiments, the ranging apparatus may be configured to sense external environment information, for example, distance information of an environment target, orientation information, reflection intensity information, speed information, etc. In some embodiments, the ranging apparatus may be configured to detect a distance from a detected object to the ranging apparatus by measuring light transmission time, i.e., time-of-flight (TOF), between the ranging apparatus and the detected object. In some other embodiments, the ranging apparatus may be configured to detect the distance from the detected object to the ranging apparatus through another technology, for example, a ranging method based on phase shift measurement or frequency shift measurement, which is not limited here.

To facilitate understanding, an operation process for ranging is described as an example in connection with a ranging apparatus 100 shown in FIG. 6.

As shown in FIG. 6, the ranging apparatus 100 includes an emission circuit 110, a reception circuit 120, a sampling circuit 130, and a computation circuit 140.

The emission circuit 110 may be configured to emit a light pulse sequence (e.g., a laser pulse sequence). The reception circuit 120 may be configured to receive the light pulse sequence reflected by the detected object, perform photoelectric conversion on the light pulse sequence to obtain an electrical signal, and output the processed electrical signal to the sampling circuit 130. The sampling circuit 130 may be configured to perform sampling on the electrical signal to obtain a sampling result. The computation circuit 140 may be configured to determine the distance between the ranging apparatus 100 and the detected object based on the sampling result of the sampling circuit 130.

In some embodiments, the ranging apparatus 100 further includes a control circuit 150. The control circuit 150 may be configured to control another module or circuit. For example, the control circuit 150 may be configured to control the operation time of the modules and circuits and/or perform parameter setting on the modules and the circuits.

Although the ranging apparatus shown in FIG. 6 includes one emission circuit, one reception circuit, one sampling circuit, and one computation circuit and is configured to emit one beam for detection, the present disclosure is not limited to this. A number of any circuit of the emission circuit, the reception circuit, the sampling circuit, and the computation circuit may be at least two. The ranging apparatus may be configured to emit at least two beams along a same direction or different directions. The at least two beams may be emitted simultaneously or at different times. In some embodiments, light-emotion chips of the at least two emitters may be packaged in a same module. For example, each emitter may include a laser emission chip. The dies of the laser emission chips of the at least two emitters may be packaged together and accommodated in a same package space.

In some embodiments, in addition to the structure shown in FIG. 6, the ranging apparatus 100 further includes a scanner, which may be configured to change the transmission direction of the at least one light pulse sequence emitted by the emitter for transmission.

A module that includes the emission circuit 110, the reception circuit 120, the sampling circuit 130, and the computation circuit 140, or a module that includes the emission circuit 110, the reception circuit 120, the sampling circuit 130, the computation circuit 140, and the control circuit 150 may be referred to as a ranging device. The ranging device may be independent of another module, for example, a scanner.

In some embodiments, a co-axial optical path may be used in the ranging apparatus. That is, the light emitted from the ranging apparatus and a light reflected may share at least a part of the optical path in the ranging apparatus. For example, the at least one light of the light pulse sequence emitted by the emitter may be emitted after the transmission direction of the at least one light of the light pulse sequence is changed by the scanner. The light pulse sequence reflected by the detected object may enter the reception circuit through the scanner. In some other embodiments, off-axial optical paths may be used in the ranging apparatus. That is, the light emitted by the ranging apparatus and the light reflected may be transmitted along different paths in the ranging apparatus. FIG. 7 is a schematic diagram of a ranging apparatus 200 using a coaxial optical path according to some embodiments of the present disclosure.

The ranging apparatus 200 includes a ranging device 210. The ranging device 210 includes an emitter 203 (including the emission device), a collimation element 204, a detector 205 (including the reception circuit, the sampling circuit, and the computation circuit), and an optical path change element 206. The ranging device 210 may be configured to emit a light, receive a return light, and convert the return light into an electrical signal. The emitter 203 may be configured to emit a light pulse sequence. In some embodiments, the emitter 203 may emit a light pulse sequence. In some embodiments, the laser light emitted by the emitter 203 may include a narrow bandwidth light with a wavelength outside of a visible light range. The collimation element 204 may be arranged on an emission path of the emitter 203 and further configured to collimate the light emitted from the emitter 203 into parallel light to emit to the scanner. The collimation element 204 may be further configured to converge at least a part of the return light reflected by the detected object. The collimation element 204 may include a collimation lens or another element that can collimate the light.

In some embodiments shown in FIG. 7, an emission optical path and a reception optical path of the ranging apparatus may be combined through the optical path change element 206 before the collimation element 204. Thus, the emission optical path and the reception optical path may share the same collimation element to cause the optical path to be more compact. In some other embodiments, each of the emitter 203 and the detector 205 may include a collimation element 204. The optical path change element 206 may be arranged at the optical path after the collimation element 204.

In some embodiments shown in FIG. 7, since a diameter of a light hole of the emitter 203 for emitting the beam is relatively small, and a diameter of a light hole of the ranging apparatus for receiving the returned beam is relatively large, the optical path change element may use a reflection mirror with a small area to combine the emission optical path and the reception optical path. In some other embodiments, the optical path change element may also include a reflection mirror with a through-hole. The through-hole may be configured to transmit the emitted light of the emitter 203. The reflection mirror may be configured to reflect the return light to the detector 205. As such, when a small reflection mirror is used, shielding of the return light by the holder of the small reflection mirror may be reduced.

In some embodiments shown in FIG. 7, the optical path change element 206 may be off the optical path of the collimation element 204. In some other embodiments, the optical path change element 206 may be located on the optical path of the collimation element 204.

The ranging apparatus 200 further includes a scanner 202. The scanner 202 is arranged at the emission optical path of the ranging device 210. The scanner 202 may be configured to change a transmission direction of a collimated light 219 emitted through the collimation element 204 and project to an external environment, and project the return light to the collimation element 204. The return light may be converged at the detector 205 through the collimation element 204.

In some embodiments, the scanner 202 may include at least one optical element, which may be configured to change the transmission direction of the light. The optical element may be configured to change the transmission direction of the light by performing reflection, refraction, and diffraction on the light. For example, the scanner 202 may include a lens, a reflection mirror, a prism, a galvanometer, a grating, a liquid crystal, an optical phased array, or any combination thereof. In some embodiments, at least a part of the optical elements may be movable. For example, at least a part of the optical elements may be driven to move by a drive module. The movable optical elements may reflect, refract, and diffract the light to different directions at different times. In some embodiments, a plurality of optical elements of the scanner 202 may rotate or vibrate around a shared axis 209. Each rotating or vibrating optical element may be configured to continuously change a transmission direction of an incident light. In some embodiments, the plurality of optical elements of the scanner 202 may rotate at different rotation speeds or vibrate at different speeds. In some other embodiments, at least the part of the optical elements of the scanner 202 may rotate at a nearly same rotation speed. In some other embodiments, the plurality of optical elements of the scanner may rotate around different rotation axes. In some other embodiments, the plurality of optical elements of the scanner may rotate in a same direction or in different directions, or vibrate in a same direction or different directions, which is not limited here.

In some embodiments, the scanner 202 includes a first optical element 214 and a driver 216 connected to the first optical element 214. The driver 216 may be configured to drive the first optical element 214 to rotate around the rotation axis 209 to cause the first optical element 214 to change the direction of the collimated light 219. The first optical element 214 may project the collimated light 219 in different directions. In some embodiments, an included angle between the direction of the collimated light 219 after the first optical element and the rotation axis 209 may change as the first optical element 214 rotates. In some embodiments, the first optical element 214 includes a pair of opposite surfaces that are not parallel. The collimated light 219 may pass through the pair of surfaces. In some embodiments, the first optical element 214 may include at least a lens, whose thickness changes along a radial direction. In some embodiments, the first optical element 214 may include a wedge prism, which may be configured to refract the collimated light 219.

In some embodiments, the scanner 202 further includes a second optical element 215. The second optical element 215 may rotate around the rotation axis 209. The second optical element 215 and the first optical element 214 may have different rotation speeds. The second optical element 215 may be configured to change the direction of the light projected by the first optical element 214. In some embodiments, the second optical element 215 may be connected to another driver 217. The driver 217 may be configured to drive the second optical element 215 to rotate. The first optical element 214 and the second optical element 215 may be driven by the same driver or different drivers to cause the rotation speeds and/or the rotation directions of the first optical element 214 and the second optical element 215 to be different. Thus, the collimated light 219 may be projected to different directions of external space to scan a relatively large space area. In some embodiments, a controller 218 may be configured to control the drivers 216 and 217 to drive the first optical element 214 and the second optical element 215, respectively. The rotation speeds of the first optical element 214 and the second optical element 215 may be determined according to an expected scan area and style in practical applications. The drivers 216 and 217 may include motors or other drivers.

In some embodiments, the second optical element 215 may include a pair of opposite surfaces that are not parallel. The beam may pass through the pair of surfaces. In some embodiments, the second optical element 215 may include at least a lens whose thickness changes along a radial direction. In some embodiments, the second optical element 215 may include a wedge prism.

In some embodiments, the scanner 202 may include a third optical element (not shown in the figure) and a driver for driving the third optical element. In some embodiments, the third optical element may include a pair of opposite surfaces that are not parallel. The beam may pass through the pair of surfaces. In some embodiments, the third optical element may include at least a lens whose thickness changes along a radial direction. In some embodiments, the second optical element 215 may include a wedge prism. At least two of the first optical element, the second optical element, and the third optical element may rotate at different rotation speeds and/or in different directions.

The optical elements of the scanner 202 may rotate to project a light to different directions, for example, a direction 213 of the projected light 211. As such, the scanner 202 may scan the space around the ranging apparatus 200. When the projected light 211 of the scanner 202 encounters the detected object 201, a part of the light may be reflected by the detected object 201 along an opposite direction to the direction of the projected light 211 to the ranging apparatus 200. The return light 212 reflected by the detected object 201 may be incident to the collimation element 204 after passing through the scanner 202.

The detector 205 and the emitter 203 may be arranged at a same side of the collimation element 204. The detector 205 may be configured to convert at least the part of the return light that passes through the collimation element 204 into an electrical signal.

In some embodiments, the optical elements may be coated with an anti-reflection film. In some embodiments, the thickness of the anti-reflection film may be equal to or close to a wavelength of the light emitted by the emitter 203. The anti-reflection film may increase the intensity of the transmitted light.

In some embodiments, a filter layer may be coated on a surface of an element of the ranging apparatus in the transmission path of the light, or a filter may be arranged in the transmission path of the light, which may be configured to transmit the light with a wavelength within the wavelength band of the light emitted by the emitter and reflect the light of another wavelength band. Thus, the noise caused by environmental light may be reduced for the receiver.

In some embodiments, the emitter 203 may include a laser device. The light pulse in the nano-second level may be emitted by the laser device. Further, the reception time of the light pulse may be determined. For example, the reception time of the light pulse may be determined by detecting at least one of the ascending edge time or the descending edge time of the electrical signal pulse. For example, the ranging apparatus 200 may calculate the TOF by using the pulse reception time information and the pulse transmission time information to determine the distance between the detected object 201 and the ranging apparatus 200.

The distance and orientation detected by the ranging apparatus 200 may be used for remote sensing, obstacle avoidance, surveying and mapping, modeling, navigation, etc. In some embodiments, the ranging apparatus of embodiments of the present disclosure may be applied to a mobile platform. The ranging apparatus may be mounted at a platform body of the mobile platform. The mobile platform having the ranging apparatus may perform measurement on the external environment. For example, a distance between the mobile platform and an obstacle may be measured to avoid the obstacle, and 2-dimensional and 3-dimensional surveying and mapping may be performed on the external environment. In some embodiments, the mobile platform may include at least one of an unmanned aerial vehicle (UAV), a vehicle (including a car), a remote vehicle, a ship, a robot, or a camera. When the ranging apparatus is applied to the UAV, the platform body may be a vehicle body of the UAV. When the ranging apparatus is applied to the car, the platform body may be a body of the car. The car may include an auto-pilot car or a semi-auto-pilot car, which is not limited here. When the ranging apparatus is applied to the remote vehicle, the platform body may be the vehicle body of the remote vehicle. When the ranging apparatus is applied to the robot, the platform body may be the robot. When the ranging apparatus is applied to the camera, the platform body may be a camera body.

Although exemplary embodiments have been described herein with reference to the accompanying drawings, described exemplary embodiments are merely exemplary, and are not intended to limit the scope of the present disclosure. Those of ordinary skill in the art may make various changes and modifications without departing from the scope and spirit of the present disclosure. All these changes and modifications are intended to be included in the scope of the present invention as claimed in the appended claims.

Those of ordinary skill in the art may be aware that the units and algorithm steps of the examples described in embodiments of the present disclosure may be implemented by electronic hardware or a combination of computer software and electronic hardware. Whether these functions are executed by hardware or software depends on the specific application and design constraint conditions of the technical solution. Those skilled in the art may use different methods for each specific application to implement the described functions, but such implementation should not be considered as going beyond the scope of the present disclosure.

In some embodiments of the present disclosure, the disclosed device and method may be implemented in another manner. For example, device embodiments described above are only illustrative. For example, the division of the units is only a logical functional division, and another division may exist in actual implementation, for example, a plurality of units or components may be combined or integrated into another device, or some features can be ignored or not implemented.

In the specification provided here, a lot of specific details are described. However, embodiments of the present disclosure may be practiced without these specific details. In some embodiments, well-known methods, structures, and technologies are not shown in detail. Thus, the understanding of this specification may not be obscured.

Similarly, to simplify the present disclosure and help understand one or more of the various aspects of the disclosure, in the description of exemplary embodiments of the present disclosure, the various features of the present disclosure may be sometimes grouped together into a single embodiment, a figure, or its description. However, the method of the present disclosure should not be interpreted as reflecting the intention that the claimed present invention requires more features than those explicitly stated in each claim. More precisely, as reflected in the corresponding claims, the point of the invention is that the corresponding technical problems can be solved with features that are less than all the features of a single disclosed embodiment. Therefore, the claims following specific embodiments are thus explicitly incorporated into the specific embodiments. Each claim itself serves as a separate embodiment of the present invention.

Those skilled in the art can understand that in addition to mutual exclusion between the features, all features disclosed in the specification (including the accompanying claims, abstract, and drawings) and all processes or units of any method or device disclosed in this manner can be combined by any combination. Unless expressly stated otherwise, each feature disclosed in this specification (including the accompanying claims, abstract, and drawings) may be replaced by an alternative feature providing the same, equivalent or similar purpose.

In addition, those skilled in the art may understand that although some embodiments described herein include certain features included in other embodiments but not other features, the combination of features of different embodiments means that they are within the scope of the present disclosure and form different embodiments. For example, in the claims, any one of the claimed embodiments may be used in any combination.

Various component embodiments of the present disclosure may be implemented by hardware, or by a software module that runs on one or more processors, or by a combination of the hardware and the software module. Those skilled in the art should understand that a microprocessor or a digital signal processor (DSP) may be used in practice to implement some or all of the functions of some modules according to embodiments of the present disclosure. The present disclosure may be further implemented as a device program (for example, a computer program and a computer program product) for executing a part or all of the methods described here. Such a program for realizing the present disclosure may be stored on a computer-readable medium or may include the forms of one or more signals. Such a signal may be downloaded from an Internet website, or provided in a carrier signal, or provided in any other forms.

The above-mentioned embodiments may be used to describe rather than limit the present disclosure. Those skilled in the art can design alternative embodiments without departing from the scope of the appended claims. In the claims, any reference signs located between parentheses should not be constructed as a limitation to the claims. The present disclosure may be implemented with the support of hardware including several different elements and a suitably programmed computer. In the unit claims listing several devices, several of these devices may be embodied in the same hardware item. The use of the words first, second, and third, etc. do not indicate any order. These words can be interpreted as names.

What is claimed is:

1. A ranging apparatus comprising:
an emitter configured to emit a light pulse sequence; and
a detector configured to receive and convert a portion of return light reflected by an object into an electrical signal and determine at least one of a distance or an orientation of the object relative to the ranging apparatus according to the electrical signal;
wherein:
at least one of an anti-reflection material or a reflective surface with a predetermined inclined angle is arranged at a non-working surface off an emission optical path of the light pulse sequence and a reception optical path of the return light and is configured to reflect stray light to outside of the detector; and
the non-working surface includes a surface of the ranging apparatus that the light pulse sequence and the return light do not pass through.

2. The ranging apparatus of claim 1, further comprising:
a structure member, the non-working surface including a portion of a surface of the structure member.

3. The ranging apparatus of claim 1, further comprising:
an optical path change element configured to change a direction of the emission optical path or the reception optical path to combine the emission optical path and the reception optical path;
wherein:
the optical path change element includes a light transmission area; and
the non-working surface includes an area of a surface of the optical path change element facing the emitter that receives a portion of the light pulse sequence other than a portion of the light pulse sequence that passes through the light transmission area.

4. The ranging apparatus of claim 3, wherein the non-working surface includes a whole surface of the optical path change element facing the emitter other than the light transmission area.

5. The ranging apparatus of claim 3, wherein the optical path change element includes a reflection mirror with the light transmission area in a central area, a divergence angle of the light pulse sequence emitted by the emitter being greater than an opening angle of the light transmission area relative to the emitter.

6. The ranging apparatus of claim 3, wherein the non-working surface further includes a surface that faces the emitter and is opposite to the light transmission area.

7. The ranging apparatus of claim 1, wherein the non-working surface includes a portion of a surface of a structure member configured to support the optical path change element.

8. The ranging apparatus of claim 1, further comprising:
a collimation element located on the emission optical path and configured to collimate and emit the light pulse sequence and converge a portion of the return light to the detector; and
a structure member configured to support the collimation element, the non-working surface includes a surface of the structure member that reflects the stray light to the detector.

9. The ranging apparatus of claim 1, further comprising:
a scanner configured to change a transmission path of the light pulse sequence to different directions in sequence for emission, the scanner including an optical element configured to change the transmission path of the light pulse sequence.

10. The ranging apparatus of claim 9, wherein:
the optical element includes:
two non-parallel surfaces that are opposite to each other; and
a side surface located at a circumferential edge; and
the non-working surface includes the side surface.

11. The ranging apparatus of claim 10, wherein a portion of the non-working surface of the optical element includes a surface that reflects a portion of the light pulse sequence to the detector.

12. The ranging apparatus of claim 10, wherein:
a portion of the non-working surface of the optical element includes a surface that reflects a portion of the light pulse sequence; and
the portion of the light pulse sequence is reflected at least once and/or refracted at least once to the detector after being reflected by the non-working surface.

13. The ranging apparatus of claim 9, wherein:
a thickness of the optical element increases gradually from a first end of the optical element to a second end of the optical element that is opposite to the first end;
the non-working surface of the optical element includes an end surface of the second end; and
the anti-reflection material is arranged at the end surface of the second end.

14. The ranging apparatus of claim 13, wherein the optical element includes a first optical element and a second optical element arranged along the emission optical path in sequence, the non-working surface including the end surface of the second end of the second optical element.

15. The ranging apparatus of claim 14, wherein:
the first optical element includes a wedge prism; and/or
the second optical element includes a wedge prism.

16. The ranging apparatus of claim 9, further comprising:
a structure member configured to support the optical element, the non-working surface including a surface of the structure member facing the detector that reflects a portion of the stray light to the detector.

17. The ranging apparatus of claim 1, wherein the stray light includes at least one of:
light of a portion of the light pulse sequence emitted by the emitter not for detection which is received by the detector after being reflected at least once and/or refracted at least once; or
other light received by the detector after being reflected at least once and/or refracted at least once other than the light pulse sequence and the return light.

18. The ranging apparatus of claim 1, wherein:
the anti-reflection material includes at least one of a light absorption material or a low reflection ratio material; and
the anti-reflection material is arranged at the non-working surface in a spray or adhere manner.

19. The ranging apparatus of claim 18, wherein the light absorption material includes at least one of anti-reflection oil ink, black glue, or black foam.

20. The ranging apparatus of claim 1, wherein the detector includes:
a reception circuit configured to convert the received return light into an electrical signal for output;
a sampling circuit configured to sample the electrical signal output by the reception circuit to measure a time difference from emission to reception of the light pulse sequence; and
a computation circuit configured to receive the time difference output by the sample circuit and compute and obtain a distance measurement result.

21. The ranging apparatus of claim 1, wherein the ranging apparatus includes a LIDAR.

22. A mobile platform comprising:
a platform body; and
a ranging apparatus arranged at the platform body and including:
an emitter configured to emit a light pulse sequence; and
a detector configured to receive and convert a portion of return light reflected by an object into an electrical signal and determine at least one of a distance or an orientation of the object relative to the ranging apparatus according to the electrical signal;
wherein:
at least one of an anti-reflection material or a reflective surface with a predetermined inclined angle is arranged at a non-working surface off an emission optical path of the light pulse sequence and a reception optical path of the return light and is configured to reflect stray light to outside of the detector; and
the non-working surface includes a surface of the ranging apparatus that the light pulse sequence and the return light do not pass through.
